(19) United States
(12) Patent Application Publication
(10) Pub. No.: US 2024/0183793 A1
(43) Pub. Date: Jun. 6, 2024

(54) INSPECTION DEVICE, INSPECTION METHOD, AND PROGRAM

(71) Applicant: Panasonic Intellectual Property Management Co., Ltd., Osaka (JP)

(72) Inventors: Jeffry NAINGGOLAN, Osaka (JP); Yuya SUGASAWA, Osaka (JP); Hisaji MURATA, Osaka (JP); Yoshinori SATOU, Osaka (JP)

(21) Appl. No.: 18/553,827

(22) PCT Filed: Feb. 25, 2022
(86) PCT No.: PCT/JP2022/007862

§ 371 Date: Oct. 3, 2023

(30) Foreign Application Priority Data
Apr. 5, 2021 (JP) 2021-064320

(51) Int. Cl. G01N 21/88

(52) U.S. Cl. CPC G01N 21/8851; G01N 2021/8877; G01N 2021/8887

(57) ABSTRACT

An inspection device includes an input portion and a determining portion. The input portion is configured to receive an input of an image taken of an object. The determining portion is configured to execute a first process on each of a plurality of inspection regions including a first inspection region and a second inspection region. The first process is a process relating to a determination as to quality of the object based on the image. The first inspection region includes a specific region not included in an inspection region other than the first inspection region of the plurality of inspection regions. The determining portion is configured to execute a second process. The second process is a process of determining, based on a result of the first process executed on each of the plurality of inspection regions, the quality of the object.

### TECHNICAL FIELD

The present disclosure generally relates to inspection devices, inspection methods, and programs and specifically relates to an inspection device, an inspection method, and a program which are configured to determine, based on an image taken of an object, the quality of the object.

### BACKGROUND ART

Patent Literature 1 describes an inspection device including a first divider, a second divider, a first classifier, a second classifier, and a determining portion. The first divider divides an image of an inspection object into a plurality of first partial images. The second divider divides the image into a plurality of second partial images. The first classifier classifies the plurality of first partial images into a first partial image(s) which is determined to include an abnormality and a first partial image(s) which is determined to include no abnormality. The second classifier classifies the plurality of second partial images into a second partial image(s) which is determined to include an abnormality and a second partial image(s) which is determined to include no abnormality. The determining portion determines, based on an overlap between the first partial image(s) which is determined to include the abnormality and the second partial image(s) which is determined to include no abnormality, whether or not the inspection object includes an abnormality.

### CITATION LIST

### Patent Literature

Patent Literature 1: WO 2018/235266 A1

### SUMMARY OF INVENTION

It is an object of the present disclosure to provide an inspection device, an inspection method, and a program which are configured to improve the accuracy of a quality determination of an object.

An inspection device according to an aspect of the present disclosure includes an input portion and a determining portion. The input portion is configured to receive an input of an image taken of an object. The determining portion is configured to execute a first process on each of a plurality of inspection regions including a first inspection region and a second inspection region. The plurality of inspection regions are set on the object in the image. The first process relates to a determination as to quality of the object based on the image. The first inspection region includes a specific region not included in an inspection region other than the first inspection region of the plurality of inspection regions. The determining portion is configured to execute a second process. The second process is a process of determining, based on a result of the first process executed on each of the plurality of inspection regions, the quality of the object.

An aspect inspection method according to the present disclosure includes: executing an input process of receiving an input of an image taken of an object: executing a first process relating to a determination as to quality of the object based on the image on each of the plurality of inspection regions set on the object in the image and including a first inspection region and a second inspection region: and executing a second process of determining, based on a result of the first process executed on each of the plurality of inspection regions, the quality of the object. The first inspection region includes a specific region not included in an inspection region other than the first inspection region of the plurality of inspection regions.

A program according to an aspect of the present disclosure is a program configured to cause one or more processors of a computer system to execute the inspection method.

### BRIEF DESCRIPTION OF DRAWINGS

FIG. 1 is a block diagram of an inspection device according to an embodiment:

FIGS. 2A to 2C are views of images of training data used in the inspection device:

FIGS. 3A to 3C are views of images of the training data used in the inspection device:

FIG. 4A to FIG. 4C are views of images of an object to be inspected by the inspection device:

FIG. 5A to FIG. 5C are views of images of the object to be inspected by the inspection device:

FIG. 6 is a flowchart of an inspection method according to the embodiment:

FIG. 7 is a block diagram of an inspection device according to a first variation:

FIG. 8 is a view illustrating processes of the inspection device of the first variation: and

FIG. 9 is a flowchart illustrating an inspection method according to the first variation.

### DESCRIPTION OF EMBODIMENTS

An inspection device, an inspection method, and a program according to an embodiment will be described below with reference to the drawings. Note that the embodiment described below is a mere example of various embodiments of the present disclosure. The embodiment described below may be modified in various manners depending on a design choice or any other factor without departing from the scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio.

### EMBODIMENT

### Overview

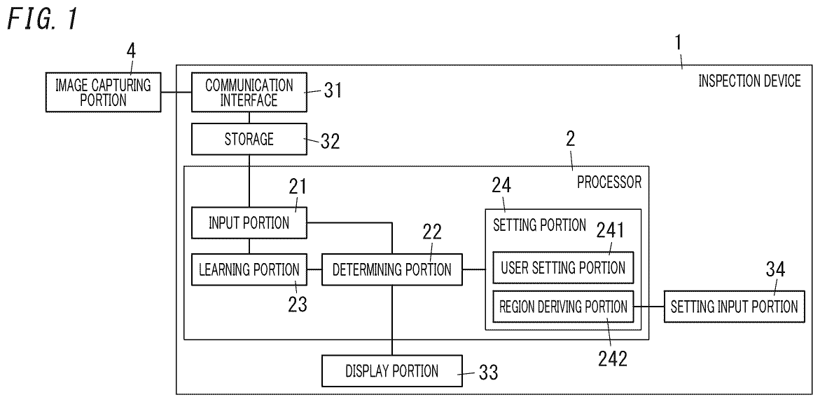

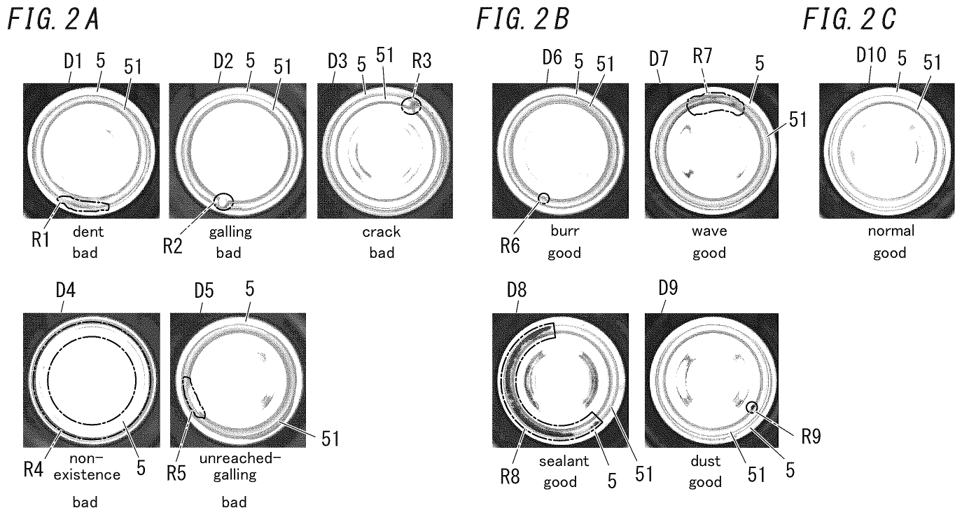

An inspection device 1 shown in FIG. 1 is to inspect a product as an example of an object 5 (see FIG. 2A). The inspection device 1 is used to determine (inspect) the quality of the object 5 in a step of manufacturing the object 5. More specifically, the inspection device 1 is used for an appearance test of the object 5. The inspection device 1 analyzes an image taken of the object 5 to determine the quality of the object 5.

As shown in FIG. 1, the inspection device 1 of the present embodiment includes an input portion 21 and a determining portion 22. The input portion 21 receives an input of the image taken of the object 5. The determining portion 22 executes a first process on each of a plurality of inspection regions including a first inspection region and a second inspection region. The plurality of inspection regions are regions on the object 5. The first process is a process relating to a determination as to quality of the object 5 based on the image. The first inspection region includes a specific region not included in an inspection region other than the first inspection region of the plurality of inspection regions. The determining portion 22 executes a second process. The second process is a process of determining, based on a result of the first process executed on each of the plurality of inspection regions, the quality of the object 5. The first process is a so-called temporary determination as to the quality, and the second process is a secondary determination based on a result of the temporary determination.

The present embodiment enables the accuracy of a quality determination of the object 5 to be improved as compared with a case where the quality determination is made based on only the first inspection region or only the second inspection region of the object 5.

Moreover, an inspection targeting the specific region is carried out only by an inspection of the first inspection region, which thus reduces a required time for the inspection as compared with the case where an inspection region other than the first inspection region includes the specific region.

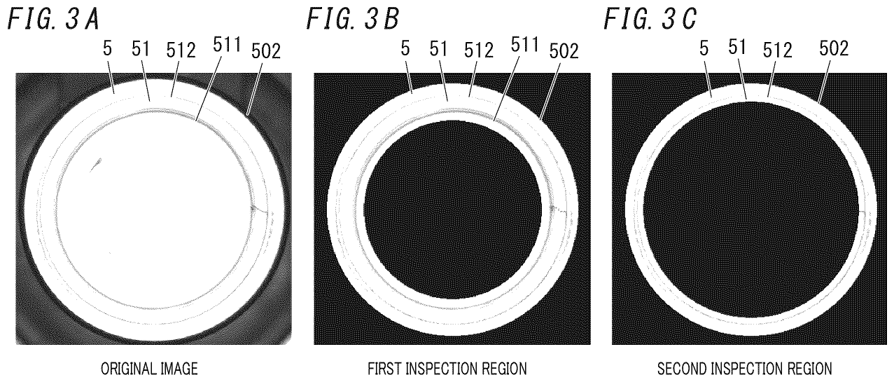

The present embodiment includes two inspection regions. That is, the plurality of inspection regions are the first inspection region and the second inspection region. An example of the first inspection region is a region obtained by excluding a first region at the center and a second region at a peripheral edge, that is, black painted regions in FIG. 3B from the entirety of an original image shown in FIG. 3A. An example of the second inspection region is a region obtained by excluding a third region at the center and the second region at the peripheral edge, that is, black painted regions in FIG. 3C from the entirety of the original image shown in FIG. 3A. The third region is larger than the first region.

### Details

### (1) Overall Configuration

As shown in FIG. 1, the inspection device 1 includes a processor 2, a communication interface 31, a storage 32, a display portion 33, and a setting input portion 34. Moreover, the inspection device 1 is used together with an image capturing portion 4. Note that the image capturing portion 4 may be included in the inspection device 1.

### (2) Image Capturing Portion

The image capturing portion 4 includes a two-dimensional image sensor such as a Charge Coupled Devices (CCD) image sensor or a Complementary Metal-Oxide Semiconductor (CMOS) image sensor. The image capturing portion 4 captures an image of the object 5 to be inspected by the inspection device 1. The image capturing portion 4 generates an image of the object 5 and outputs the image to the inspection device 1.

### (3) Communication Interface

The communication interface 31 is configured to communicate with the image capturing portion 4. As used in the present disclosure, “be configured to communicate” means that a signal can be transmitted and received based on an appropriate communication scheme, that is, wired communication or wireless communication, directly, or indirectly via a network, a relay, or the like. The communication interface 31 receives an image (image data) taken of the object 5 from the image capturing portion 4.

### (4) Storage

The storage 32 includes, for example, Read Only Memory (ROM), Random Access Memory (RAM), or Electrically Erasable Programmable Read Only Memory (EEPROM). The storage 32 receives, from the communication interface 31, the image generated by the image capturing portion 4 and stores the image. Moreover, the storage 32 stores a training data set to be used by a learning portion 23 which will be described later.

### (5) Display Portion

The display portion 33 displays a determination result by the determining portion 22. The display portion 33 includes, for example, a display. The display portion 33 displays the determination result by the determining portion 22 by using, for example, characters. More specifically, the display portion 33 displays whether a result of the determination as to the object 5 is “good” or “bad”.

### (6) Setting Input Portion

The setting input portion 34 receives an operation for setting the inspection region. The setting input portion 34 includes, for example, a pointing device, such as a mouse, and a keyboard. In the display of the display portion 33, a setting screen is displayed. The setting screen is, for example, a screen on which an image representing the shape of the object 5 is displayed. A user gives a drag operation of encircling the inspection region by using the pointing device, thereby setting the inspection region. Alternatively, the user may input a parameter specifying the inspection region by using the keyboard, thereby setting the inspection region. For example, the user specifies the shape of the inspection region in a circularly annular shape and specifies the inner diameter and the outer diameter of the inspection region, thereby setting the inspection region.

### (7) Processor

The processor 2 includes a computer system including one or more processors and memory. The processor(s) of the computer system executes a program stored in the memory of the computer system to implement at least some of functions of the processor 2. The program may be stored in the memory, may be provided over a telecommunications network such as the Internet, or may be provided as a non-transitory recording medium, such as a memory card, storing the program.

The processor 2 includes the input portion 21, the determining portion 22, the learning portion 23, and a setting portion 24. Note that these components merely represent functions implemented by the processor 2 and do not necessarily represent tangible components.

The input portion 21 receives an input of the image taken of the object 5. That is, the image generated by the image capturing portion 4 is input via the communication interface 31 to the input portion 21.

The determining portion 22 determines, based on the image input to the input portion 21, the quality of the object 5. The determining portion 22 inspects each of the plurality of inspection regions set on the object 5 to determine quality of the object 5. The details of the quality determination by the determining portion 22 will be described later.

The learning portion 23 generates, by machine learning, a determination model to be used by the determining portion 22 in the first process. In the present embodiment, as an example, the learning portion 23 generates the determination model by deep learning. The learning portion 23 generates, based on the training data set, the determination model.

Herein, the determination model is assumed to include, for example, a model using a neural network or a model generated by deep learning by using a multilayer neural network. The neural network may include, for example, Convolutional Neural Network (CNN) or Bayesian Neural Network (BNN). The determination model is embodied by implementing a learned neural network into an integrated circuit such as Application Specific Integrated Circuit (ASIC) or Field-Programmable Gate Array (FPGA). The determination model may be a model generated by, for example, a support vector machine or a decision tree.

The training data set is a collection of a plurality of pieces of training data. The training data is data obtained by combining input data (image data) to be input to the determination model and quality determined based on the input data with each other and is so-called teaching data. That is, the training data is data in which an image taken of the object 5 (see FIG. 2A) and the quality determined based on the image are associated with each other.

The features of the image and the quality determined based on the image included in the training data correspond to each other as shown in [Table 1].

TABLE 1

| | | | | |
|---|---|---|---|---|
| | | | | Including |
| | | | | Abnormal |
| | | Including | Including | Feature Which |
| | Including | Abnormal | Abnormal | Is Bad and |
| | No | Feature | Feature | Abnormal |
| Feature | Abnormal | Which Is | Which is | Feature Which |
| of Image | Feature | Not Bad | Bad | Is Not Bad |

| | | |
|---|---|---|
| Determination | Good | Bad |

As shown in [Table 1], when an image of a piece of training data includes an abnormal feature which is bad, the quality determined based on the image is defined as being “bad”. On the other hand, when an image of a piece of training data includes no abnormal feature which is bad, the quality determined based on the image is defined as being “good”. Moreover, an image of a piece of training data may include an abnormal feature which is not bad. The abnormal feature which is bad is an abnormal feature which will be a problem in terms of the quality of the object 5. The abnormal feature which is not bad is an abnormal feature which will not be a problem in terms of the quality of the object 5.

Thus, the training data set defines an object 5 having the abnormal feature which is bad as being bad and defines an object 5 having the abnormal feature which is not bad but not having the abnormal feature which is bad as being good (a non-defective product). The determination model generated by the determining portion 22 is configured such that the object 5 having the abnormal feature which is bad is highly possibly determined to be bad and the object 5 having the abnormal feature which is not bad but not having the abnormal feature which is bad is highly possibly determined to be good.

The plurality of features which the object 5 may have will be described below.

FIGS. 2A to 2C show examples of images D1 to D10 included in the training data set. The images D1 to D10 are images taken of the object 5. The object 5 in each image in FIG. 2A has the abnormal feature which is bad. The object 5 in each image in FIG. 2B has the abnormal feature which is not bad. The object 5 in the image D10 in FIG. 2C has no abnormal feature. Under each of the images D1 to D10, the name of the feature and the quality determined to be “good” or “bad” are indicated.

As shown in FIG. 2C, the object 5 has a circular shape in plan view. The object 5 has a ring 51. The outer diameter of the ring 51 is smaller than the outer diameter of the object 5. The ring 51 is concentric with the outer diameter of the object 5.

FIG. 2A will be described. The object 5 in the image D1 has, as a feature, a dent in a predetermined region R1 of the ring 51. The object 5 in the image D2 has, as a feature, galling in a predetermined region R2 of the ring 51. The object 5 in the image D3 has, as a feature, a crack in the predetermined region R3 of the ring 51. The object 5 in the image D4 has, as a feature, non-existence (absence) of a ring 51 in a region R4 in which the ring 51 is supposed to be provided. The object 5 in the image D5 has, as a feature, unreached-galling in a predetermined region R5 of the ring 51.

The galling means that a cut-off extends through the ring 51 from an inner edge to an outer edge of the ring 51. The unreached-galling means that a cut-off is formed at the inner edge of the ring 51 but the cut-off does not reach the outer edge.

FIG. 2B will be described. The object 5 in the image D6 has, as a feature, a burr in a predetermined region R6 of the ring 51. The object 5 in the image D7 has, as a feature, a wave in a predetermined region R7 of ring 51. The object 5 in the image D8 has, as a feature, a protrusion of a sealant in a predetermined region R8 of the ring 51. The object 5 of the image D9 has, as a feature, dust adhering to a predetermined region R9 of the ring 51.

In addition, the training data set may include an image of the object 5 having a plurality of features.

The training data set includes a first training data set relating to the first inspection region and a second training data set relating to the second inspection region. The learning portion 23 generates, based on the first training data set, a first determination model corresponding to the first inspection region and generates, based on the second training data set, a second determination model corresponding to the second inspection region. That is, the learning portion 23 generates a determination model for each inspection region.

Only the first inspection region is cut out from each of the plurality of images included in the training data set and is provided, as the first training data set, to the learning portion 23. Moreover, only the second inspection region is cut out from each of the plurality of images included in the training data set and is provided, as a second training data set, to the learning portion 23.

The setting portion 24 (see FIG. 1) sets at least one inspection region of the plurality of inspection regions. The learning portion 23 generates a plurality of determination models corresponding to the plurality of inspection regions set by the setting portion 24. In the present embodiment, the plurality of inspection regions are the first inspection region and the second inspection region. In the present embodiment, the setting portion 24 sets the first inspection region and the second inspection region.

As shown in FIG. 1, the setting portion 24 includes a user setting portion 241. The user setting portion 241 sets at least one inspection region of the plurality of inspection regions in response to an input given by a user. The user gives an operation to the setting input portion 34, thereby inputting setting information. The user setting portion 241 sets at least one inspection region of the plurality of inspection regions in accordance with the setting information input to the setting input portion 34.

The setting portion 24 further includes a region deriving portion 242. The region deriving portion 242 sets, based on a predetermined rule, at least one inspection region of the plurality of inspection regions. When the setting input portion 34 receives the setting information, the setting portion 24 sets the inspection region by the user setting portion 241, and when the setting input portion 34 receives no setting information, the setting portion 24 sets the inspection region by the region deriving portion 242.

The region deriving portion 242 defines the entirety of an inspection target region of the object 5 as the first inspection region. This will be described with reference to FIGS. 3A and 3B.

FIG. 3A is an image included in the training data set and taken of the object 5. The object 5 in FIG. 3A has an abnormal feature. In FIG. 3A, a substantially white region except for the peripheral portion is the entire region of the object 5. The ring 51 of the object 5 has an inner edge 511 and an outer edge 512. The object 5 has an outer edge 502 on an outer side of the outer edge 512 of the ring 51.

FIG. 3B is an image of an inspection target region extracted from the image shown in FIG. 3A. In FIG. 3B, the inspection target region is shown in white and gray, and the other regions are masked in black. The entirety of the regions in white and gray in FIG. 3B is the first inspection region to be set by the region deriving portion 242. The first inspection region has an annular shape. The first inspection region is concentric with the ring 51. The inner diameter of the first inspection region is smaller than the inner diameter of the ring 51. The outer edge of the first inspection region coincides with the outer edge 502 of the object 5.

The inspection target region may be set in accordance with the setting information input to the setting input portion 34. Alternatively, the region deriving portion 242 may analyze the plurality of images included in the training data set and set, as the inspection target region, a region which is included in the object 5 and in which an abnormal feature may occur.

Moreover, the region deriving portion 242 defines, as the second inspection region, a predetermined range of a region which is included in the object 5 and in which a predetermined “abnormal feature which is bad” may occur. More specifically, the region deriving portion 242 defines, as the second inspection region, a region which is included in the object 5, in which the predetermined “abnormal feature which is bad” may occur, and whose area ratio to the entirety of the inspection target region of the object 5 is less than or equal to a predetermined value. That is, a number obtained by dividing the area of the second inspection region by the area of the entirety of the inspection target region is smaller than the predetermined value. This will be described with reference to FIG. 3C.

FIG. 3C is an image of the second inspection region extracted from the image shown in FIG. 3A. In FIG. 3C, the second inspection region is shown in white and gray, and the other regions are masked in black. The second inspection region has an annular shape. The second inspection region is concentric with the ring 51. The inner diameter of the second inspection region is greater than the inner diameter of the ring 51 and smaller than the outer diameter of the ring 51. The second inspection region has an outer edge which coincides with the outer edge 502 of the object 5.

The second inspection region is smaller than the first inspection region. The second inspection region is included in the first inspection region. In other words, the second inspection region is part of the first inspection region. In the examples shown in FIGS. 3B and 3C, the first inspection region includes a specific region which is not included in any other inspection region (that is, not included in the second inspection region) and which is a circularly annular region on an inner side of the center between the outer edge and the inner edge of the ring 51.

The region deriving portion 242 analyzes the plurality of images included in the training data set to identify a portion which is included in the object 5 and in which the predetermined “abnormal feature which is bad” may occur. The region deriving portion 242 sets, as the second inspection region, a region which includes the portion and whose area ratio to the entirety of the inspection target region is less than or equal to the predetermined value. An example of the predetermined “abnormal feature which is bad” is a dent (see FIG. 2A).

In the following description, the first inspection region set by the setting portion 24 is assumed to be the region shown in FIG. 3B. Moreover, in the following description, the second inspection region set by the setting portion 24 is assumed to be the region shown in FIG. 3C.

### (8) First Example of Quality Determination

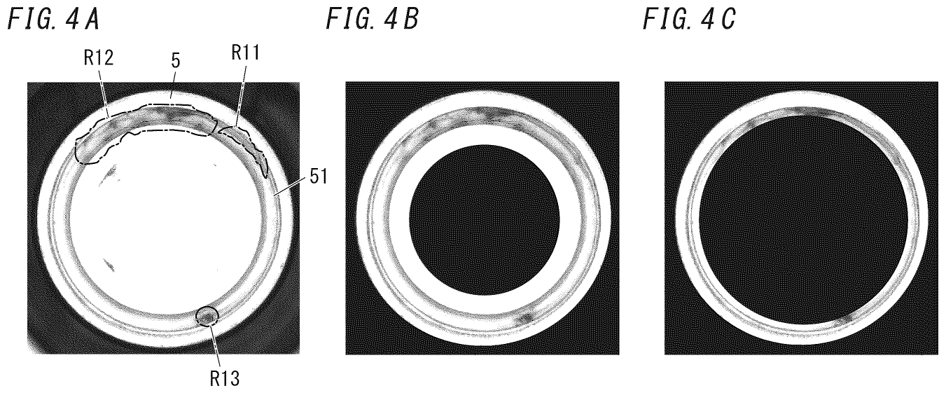

Next, the quality determination by the determining portion 22 will be described in detail. Here, a target whose quality is to be determined is assumed to be the object 5 in the image shown in FIG. 4A. The determining portion 22 executes a first process and a second process to make a quality determination of the object 5. The first determination model and the second determination model to be used in the first process are generated in advance by the learning portion 23.

As shown in FIG. 4A, the object 5 has a plurality of abnormal features. Specifically, the object 5 has a dent in a region R11, a wave in a region R12, and a protrusion of a sealant in a region R13.

FIG. 4B is an image of the first inspection region extracted from the image shown in FIG. 4A. FIG. 4C is an image of the second inspection region extracted from the image shown in FIG. 4A.

In the first process, the determining portion 22 determines the quality of each of the plurality of inspection regions. In the second process, the determining portion 22 comprehensively determines, based on a determination result in the first process, the quality of the object 5. More specifically, when for at least one of the plurality of inspection regions, the determination that the quality is bad is made in the first process, the determining portion 22 determines that the object 5 is bad in the second process. On the other hand, when for each of all the plurality of inspection regions, the determination that the quality is good is made in the first process, the determining portion 22 determines that the object 5 is good in the second process.

Much more specifically, when the determining portion 22 determines, in the first process, that the object 5 has the abnormal feature which is bad in a predetermined inspection region, the determining portion 22 defines the result of the first process executed on the predetermined inspection region as being bad. On the other hand, when the determining portion 22 determines that the object 5 has the abnormal feature which is not bad but the object 5 has no abnormal feature which is bad in the predetermined inspection region, the determining portion 22 defines the result of the first process in the predetermined inspection region as being good. The predetermined inspection region is included in the plurality of inspection regions. In other words, the predetermined inspection region is one of the plurality of inspection regions. In the present embodiment, both the first inspection region and the second inspection region correspond to the predetermined inspection region.

In the first process, the determining portion 22 calculates determination values each representing the level of the quality of the plurality of inspection regions of the object 5 on a one-to-one basis. Here, each determination value is assumed to be an “NG confidence level”. The NG confidence level is a value greater than or equal to 0 and less than or equal to 1. The closer the NG confidence level is to 1, the higher the possibility of the object 5 being bad. The closer the NG confidence level is to 0, the higher the possibility of the object 5 being good.

An example of a calculation process of the NG confidence level will be described below. The storage 32 stores a feature amount of an image of each piece of training data. In the first process, the determining portion 22 extracts, from an image input to the input portion 21 (hereinafter referred to as an input image), an input feature amount which is the feature amount of the input image. The determining portion 22 obtains an index relating to similarity between the input feature amount and the feature amount of the image of each piece of training data. The index relating to the similarity is, for example, an index in a fully connected layer directly before an output layer in the deep learning and is a Euclidean distance in the present embodiment. The “distance” which is an index of similarity may be Mahalanobis' generalized distance, Manhattan distance, Chebyshev distance, or Minkowski distance besides the Euclidean distance. Moreover, the index is not limited to the distance but may be similarity, correlation coefficient, or the like and may be, for example, the similarity of n-dimensional vectors, cosine similarity, a Pearson correlation coefficient, deviation pattern similarity, a Jaccard index, a Dice coefficient, or a Simpson's Coefficient. The index of similarity is hereinafter simply referred to as a “distance”.

For the feature amount of an image of training data, a shorter distance from the input feature amount means that the image of the training data is an image similar to the input image. The determination model of the determining portion 22 compares a distance from the input feature amount to the feature amount of the image of each piece of training data between the plurality of pieces of training data. The determination model identifies an image having a small distance to the input image of the plurality of images of the training data set and calculates, based on the quality determined to be “good” or “bad” and associated with the image thus identified, the determination value (the NG confidence level) representing the level of the quality of the input image (object 5).

The determining portion 22 calculates, based on the image of the first inspection region shown in FIG. 4B, the NG confidence level of the first inspection region. That is, the determining portion 22 inputs the image of the first inspection region to the first determination model generated by the learning portion 23, thereby obtaining the NG confidence level of the first inspection region. Moreover, the determining portion 22 calculates, based on the image of the second inspection region shown in FIG. 4C, the NG confidence level of the second inspection region. That is, the determining portion 22 inputs the image of the second inspection region to the second determination model generated by the learning portion 23, thereby obtaining the NG confidence level of the second inspection region.

In the first process, if the NG confidence level is greater than a threshold which is predetermined, the determining portion 22 determines that the quality is “bad”, whereas if the NG confidence level is less than or equal to the threshold, the determining portion 22 determines that the quality is “good”. In the examples shown in FIGS. 4B and 4C, the quality determined based on the first inspection region is “good”, and the quality determined based on the second inspection region is “bad”. As described above, when the quality is determined to be “bad” for at least one of the plurality of inspection regions (the first inspection region and the second inspection region) in the first process, the determining portion 22 determines that the object 5 is “bad” in the second process. Thus, in the examples shown in FIGS. 4B and 4C, the determining portion 22 determines that the object 5 is “bad”. The object 5 actually has the abnormal feature (dent) which is bad, and thus, the determination by the determining portion 22 is correct.

### (9) Advantages

According to the inspection device 1 of the present embodiment, the accuracy of the quality determination of the object 5 can be improved. This will be described below in detail.

The training data set includes at least an image including only an “abnormal feature which is bad” and an image including only an “abnormal feature which is not bad”. Thus, when the object 5 has only one or more “abnormal features which are bad”, or when the object 5 has only one or more “abnormal features which are not bad”, a quality determination based on only the first inspection region may satisfactorily increase the accuracy of the quality determination.

In contrast, when the object 5 has the “abnormal feature which is bad” and the “abnormal feature which is not bad” as shown in FIG. 4A, the quality correctly has to be determined to be “bad” (see [Table 1]). However, when the feature amount of the “abnormal feature which is not bad” more contributes to the quality determination than the feature amount of the “abnormal feature which is bad”, the determining portion 22 may erroneously determine the quality to be “good” in the quality determination based on the first inspection region.

Moreover, for example, the distance between the feature amount of the dent and the feature amount of the wave is small, and therefore, in the determination based on the first inspection region, the determining portion 22 may confuse the dent of the object 5 with the wave. That is, the determining portion 22 may confuse the dent which is the abnormal feature which is bad with the wave which is the abnormal feature which is not bad. As a result, the determining portion 22 may erroneously determine that the object 5 is “good”.

Therefore, in the present embodiment, the determining portion 22 makes the quality determination not only based on the first inspection region in the first process but also based on the second inspection region in the first process. As shown in FIG. 4A, the wave which is the “abnormal feature which is not bad” may occur in the region R12. The first inspection region includes the entirety of the region R12, and the second inspection region includes only part of the region R12. On the other hand, the dent which is the “abnormal feature which is bad” may be occur in the region R11. The first inspection region includes the entirety of the region R11, and the second inspection region also includes substantially the entirety of the region R11.

The “area ratio of the abnormal feature which is bad” is defined as a ratio of the area of the abnormal feature which is bad to the area of the entirety of the first inspection region or the second inspection region. The “area ratio of the abnormal feature which is bad” in the second inspection region is greater than the “area ratio of the abnormal feature which is bad” in the first inspection region. Thus, the contribution of the “abnormal feature which is bad” to the quality determination is greater in the second inspection region than in the first inspection region. In other words, the contribution of the “abnormal feature which is bad” to the NG confidence level is greater in the second inspection region than in the first inspection region. Thus, the NG confidence level of the second inspection region is higher than the NG confidence level of the first inspection region. That is, in the first process, the possibility that the quality determined based on the second inspection region is “bad” is higher than the possibility that the quality determined based on the first inspection region is “bad”. When the quality determined based on the second inspection region is “bad”, the determining portion 22 determines that the object 5 is “bad” in the second process. That is, the possibility that the determining portion 22 makes a correct determination increases.

### (10) Second Example of Quality Determination

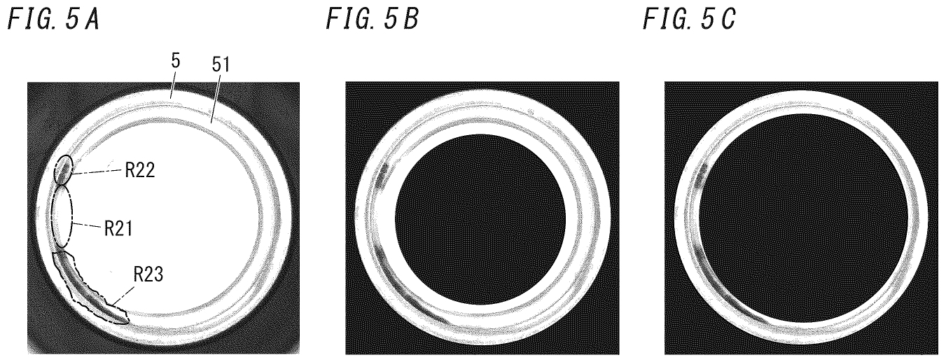

Next, with reference to FIGS. 5A to 5C, another example of the quality determination by the determining portion 22 will be described. Here, a target whose quality is to be determined is assumed to be the object 5 in the image shown in FIG. 5A. The second example is different from the first example only in the target whose quality is to be determined, and the method of determining the quality in the second example is the same as that in the first example.

As shown in FIG. 5A, the object 5 has a plurality of abnormal features. Specifically, the object 5 has unreached-galling in the region R21 and protrusions of a sealant in the regions R22 and R23. The unreached-galling is formed on an inner edge side of the ring 51.

FIG. 5B is an image of the first inspection region extracted from the image shown in FIG. 5A. FIG. 5C is an image of the second inspection region extracted from the image shown in FIG. 5A.

The determining portion 22 inputs an image of the first inspection region to the first determination model generated by the learning portion 23, thereby obtaining the NG confidence level of the first inspection region. Moreover, the determining portion 22 inputs an image of the second inspection region to the second determination model generated by the learning portion 23, thereby obtaining the NG confidence level of the second inspection region.

In the first process, when the NG confidence level is higher than the predetermined threshold, the determining portion 22 determines that the quality is “bad”, and when the NG confidence level is lower than or equal to the threshold, the determining portion 22 determines that the quality is “good”. In the examples shown in FIGS. 5B and 5C, the quality determined based on the first inspection region is “bad”, and the quality determined based on the second inspection region is “good”. Thus, in the second process, the determining portion 22 determines that the object 5 is “bad”. The object 5 actually has an abnormal feature (unreached-galling) which is bad, and therefore, the determination by the determining portion 22 is correct.

The distance between the feature amount of the unreached-galling and each of the other feature amounts is relatively long, and therefore, the possibility that the unreached-galling is confused with the other features is low. Thus, the determining portion 22 can find the unreached-galling by the determination made based on the first inspection region. That is, the result of the determination based on the first inspection region is “bad”.

Thus, the determining portion 22 can find both the dent which occurs on an outer edge side of the ring 51 and the unreached-galling which occurs on the inner edge side of the ring 51 in a common process using the first determination model and the second determination model. The contents of the process do not have to be changed, the first determination model does not have to be changed, and moreover, the second determination model does not have to be changed.

### (11) Inspection Method

As can be seen from the contents explained above, the inspection method of the present embodiment includes executing the input process, executing the first process on each of the plurality of inspection regions including the first inspection region and the second inspection region, and executing the second process. The plurality of inspection regions are regions on the object 5. The input process is a process of receiving an input of an image taken of the object 5. The first process is a process relating to a determination as to quality of the object 5 based on the image. The second process is a process of determining, based on a result of the first process executed on each of the plurality of inspection regions, the quality of the object 5. The first inspection region includes a specific region not included in an inspection region other than the first inspection region of the plurality of inspection regions.

A program according to an aspect is a program configured to cause one or more processors of a computer system to execute the inspection method. The program may be stored in a computer readable non-transitory recording medium.

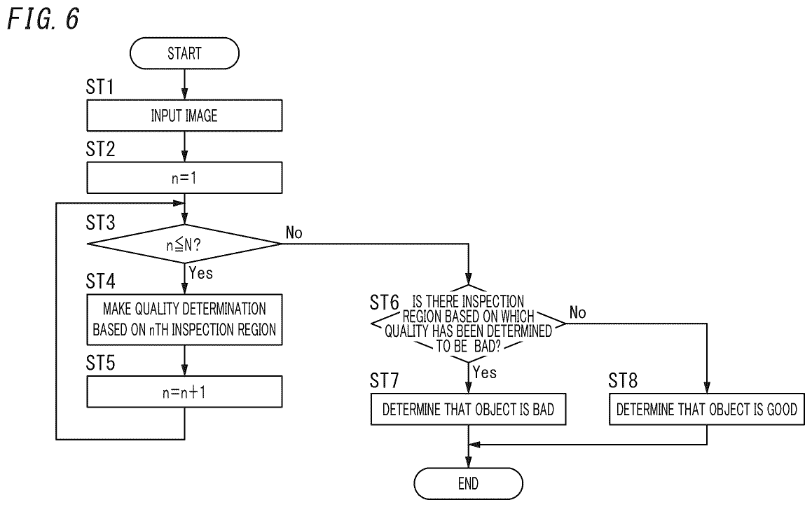

The inspection method of the present embodiment will be described in further detail with reference to FIG. 6. First of all, an image taken of the object 5 to be inspected is input to the input portion 21 (step ST1). Then, 1 is assigned to a parameter n (step ST2). N is the number of inspection regions (in the present embodiment, N=2). When n≤ N (step ST3: Yes), the determining portion 22 makes a quality determination for an image of the nth inspection region (step ST4). Thereafter, 1 is added to n (step ST5), and the process returns to the step ST3.

If the quality determination for the image of each of N inspection regions is completed (step ST3: No), step ST6 is executed. In the step ST6, whether or not the N inspection regions include at least one inspection region based on which the quality has been determined to be bad is determined. If the determination in the step ST6 is true (Yes), the determining portion 22 determines that the object 5 is bad (step ST7). In contrast, if the determination in the step ST6 is not true (No), the determining portion 22 determines that the object 5 is good (step ST8).

Note that the flowchart shown in FIG. 6 is a mere example of the inspection method of the present disclosure, and therefore, the order of processes may accordingly be changed, or a process(es) may accordingly be added or omitted.

### (First Variation)

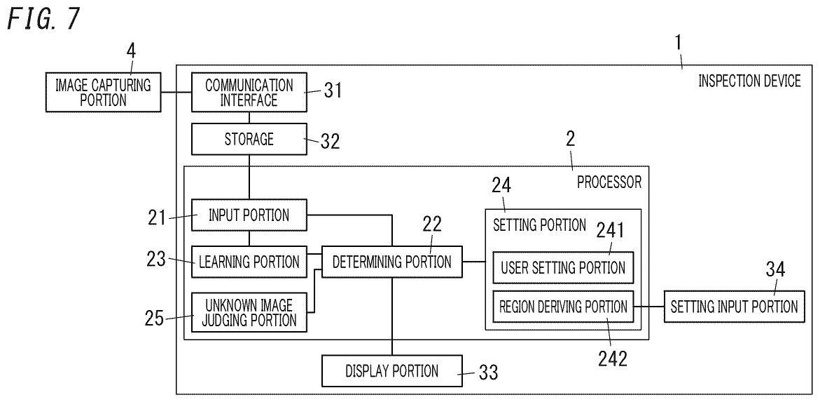

With reference to FIG. 7 to FIG. 9, an inspection device 1A according to a first variation will be described below. Components similar to those in the embodiment are denoted by the same reference signs as those in the embodiment, and the description thereof will be omitted.

As shown in FIG. 7, the inspection device 1A of the first variation further includes an unknown image judging portion 25. The unknown image judging portion 25 is a component of the processor 2. The unknown image judging portion 25 judges (determines) whether or not an image input to the input portion 21 is an unknown image to which no image in the training data set corresponds. When the feature amount of the image input to the input portion 21 is significantly different from each of the feature amounts of the plurality of images in the training data set, the unknown image judging portion 25 judges that the image input to the input portion 21 to be an unknown image to which no image in the training data set corresponds. The determining portion 22 determines, further based on a judgement result by the unknown image judging portion 25, the quality of the object 5.

The training data set used for learning by the learning portion 23 includes a plurality of images. The feature amount of each of the plurality of images is stored in the storage 32.

The inspection device IA inspects the object 5 in a predetermined step of a plurality of steps for manufacturing the object 5. An example of the unknown image is an image taken of the object 5 in a step different from the predetermined step of the plurality of steps. Another example of the unknown image is an image including no object 5.

The unknown image judging portion 25 extracts an input feature amount which is the feature amount of the image input to the input portion 21. The unknown image judging portion 25 calculates the distance between the input feature amount and the feature amount of each of the plurality of images included in the training data set in a feature amount space. If the distance between the input feature amount and a feature amount which is included in the feature amounts of the plurality of images and which is closest to the input feature amount is greater than the threshold in the feature amount space, the unknown image judging portion 25 judges that the image input to the input portion 21 is the unknown image. If the distance is less than the threshold, the unknown image judging portion 25 judges that the image input to the input portion 21 is not the unknown image.

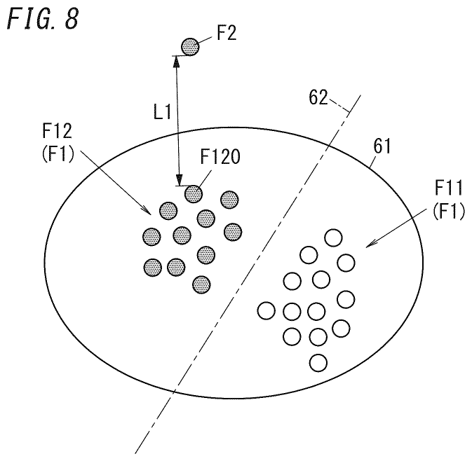

In FIG. 8, the feature amount space is schematically shown. In FIG. 8, to simplify the drawing, the feature amount space is shown as a two-dimensional space. A space 61 includes feature amounts F1 of the respective plurality of images included in the training data set. A boundary 62 is a boundary between feature amounts F11 of images each including the abnormal feature which is bad and feature amounts F12 of images each including no abnormal feature which is bad.

The unknown image judging portion 25 calculates a distance L1 between an input feature amount F2 and a feature amount F120 which is included in the feature amounts F1 of the plurality of images included in the training data set and which is closest to the input feature amount F2. In the present embodiment, a Euclidean distance is used as the distance L1. The distance L1 may be Mahalanobis' generalized distance, Manhattan distance, Chebyshev distance, or Minkowski distance instead of the Euclidean distance.

If the distance L1 is greater than or equal to a threshold, the unknown image judging portion 25 judges that the image input to the input portion 21 is an unknown image. If the unknown image judging portion 25 judges that the image input to the input portion 21 is the unknown image, the determining portion 22 determines that the object 5 is bad. That is, when the unknown image judging portion 25 judges that an image taken of the object 5 is an unknown image, the determining portion 22 determines that the object 5 is bad regardless of a result of the second process.

When the image is an unknown image, there may be both the case where the object 5 is good and the case where the object 5 is bad. However, defining a result of a determination based on the unknown image as being bad enables a defective product to be further reliably excluded.

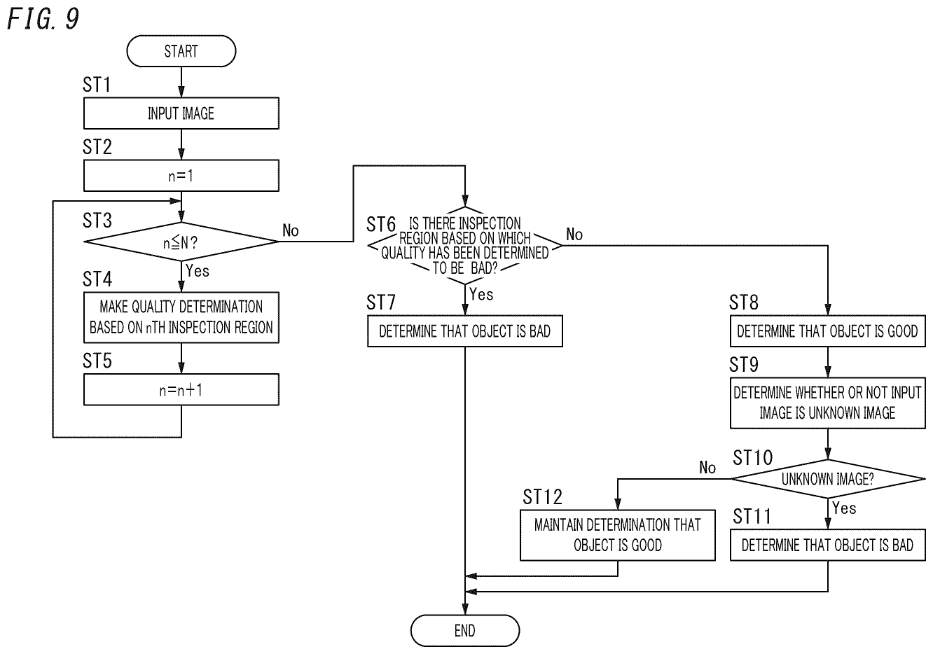

For an inspection method including a process by the unknown image judging portion 25 will be described with reference to FIG. 9. The inspection method in the first variation is based on the flow of the inspection method shown in FIG. 6 of the embodiment to which steps ST9 to ST12 are added.

If the object 5 in an image which is a determination target is determined to be good in the step ST8, the unknown image judging portion 25 judges whether or not the image which is the determination target is the unknown image (step ST9). If the image which is the determination target is judged to be an unknown image (step ST10: Yes), the determining portion 22 retracts the determination that the object 5 is good and then determines that the object 5 is bad (step ST11). On the other hand, the image which is the determination target is judged not to be the unknown image (step ST10: No), the determining portion 22 maintains the determination that the object 5 is good (step ST12).

Note that the flowchart shown in FIG. 9 is a mere example of the inspection method according to the present disclosure, and the order of processes may accordingly be changed or a process(es) may accordingly be added or omitted. For example, after whether or not the image input to the input portion 21 is an unknown image is judged, the quality determination of the object 5 may be made based on each of the plurality of inspection regions.

### (Second Variation)

The inspection device 1 according to a second variation will be described below. Components similar to those in the embodiment are denoted by the same reference signs as those in the embodiment, and the description thereof will be omitted. The second variation is applicable accordingly in combination with the first variation described above.

In the first process, the determining portion 22 calculates determination values each representing the level of the quality of the object 5 for the plurality of inspection regions on a one-to-one basis. In the second variation, the determination value is assumed to be an NG confidence level as in the embodiment. In the first process, the same number of determination values as the number of inspection regions are calculated.

In the second process, the determining portion 22 determines, based on the sum of the determination values calculated in the first process, the quality of the object 5. For example, if the sum of the determination values (NG confidence level) is greater than the predetermined threshold, the determining portion 22 determines that the object 5 is bad, whereas if the sum of the determination values is less than or equal to the predetermined threshold, the determining portion 22 determines that the object 5 is good.

The sum of the determination values is not limited to a value obtained by simply adding up the plurality of determination values. For example, after each determination value is weighted, a value obtained by adding up the plurality of determination values may be defined as the sum of the determination values.

### (Third Variation)

An inspection device 1 according to a third variation will be described below. Components similar to those in the embodiment are denoted by the same reference signs as those in the embodiment, and the description thereof will be omitted. The third variation is applicable accordingly in combination with each of the variations described above.

The number of inspection regions is not limited to two, but three or more inspection regions may be set. The number of inspection regions is assumed to be N (where N is a natural number greater than or equal to 2), and in this case, for an arbitrary i (i=2 to N), a first inspection region and at least part of the ith inspection region preferably overlap each other.

### (Fourth Variation)

An inspection device 1 according to a fourth variation will be described below.

Components similar to those in the embodiment are denoted by the same reference signs as those in the embodiment, and the description thereof will be omitted. The fourth variation is applicable accordingly in combination with each of the variations described above.

In the embodiment, a single second inspection region is set. The setting portion 24 may, however, set the second inspection region for each of features which the object 5 may have. For example, as the image D1 of FIG. 2A shows, the feature of a dent occurs at the side of an outer edge of the ring 51. Thus, in a determination model for inspecting whether or not the dent is present, a region including the periphery of the outer edge of the ring 51 may be defined as the second inspection region. On the other hand, as the image D5 of FIG. 2A shows, the feature of unreached-galling occurs at the side of an inner edge of the ring 51. Thus, a determination model for inspecting whether or not the unreached-galling is present, a region including the periphery of the inner edge of the ring 51 may be define as the second inspection region. In sum, when the inspection device 1 inspects a feature of the object 5, the setting portion 24 sets a region associated with the feature to the second inspection region. More specifically, the setting portion 24 sets the second inspection region such that a region in which the feature may occur is included in the second inspection region.

### Other Variations of Embodiment

Other variations of the embodiment will be described below. The variations described below may be accordingly combined with each other. Moreover, the following variations may be embodied accordingly in combination with each variation described above.

The inspection device 1 does not necessarily have to include the learning portion 23 for generating a determination model. The inspection device 1 may inspect the object 5 by using a determination model generated in advance.

The inspection device 1 in the present disclosure includes a computer system. The computer system may include a processor and memory as principal hardware components thereof. At least some functions of the inspection device 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the inspection device 1 are aggregated together in a single housing. However, this is not an essential configuration for the inspection device 1. Alternatively, those constituent elements of the inspection device 1 may be distributed in multiple different housings. Still alternatively, at least some functions of the inspection device 1 (e.g., some functions of the determining portion 22) may be implemented as a cloud computing system as well.

In the present disclosure, if one of two values being compared with each other is “greater than” the other, the phrase “greater than” covers only a situation where one of the two values is greater than the other. However, this should not be construed as limiting. The phrase “greater than” as used herein may also be a synonym of the phrase “equal to or greater than” that covers both a situation where these two values are equal to each other and a situation where one of the two values is greater than the other. That is to say, it is arbitrarily changeable, depending on selection of the threshold value or any preset value, whether or not the phrase “greater than” covers the situation where the two values are equal to each other. Therefore, from a technical point of view, there is no difference between the phrase “greater than” and the phrase “equal to or greater than”. Similarly, the phrase “equal to or less than” may be a synonym of the phrase “less than” as well.

### SUMMARY

The embodiment and the like described above disclose the following aspects.

An inspection device (1, 1A) of a first aspect includes an input portion (21) and a determining portion (22). The input portion (21) is configured to receive an input of an image taken of an object (5). The determining portion (22) is configured to execute a first process on each of a plurality of inspection regions including a first inspection region and a second inspection region. The plurality of inspection regions are set on the object (5) in the image. The first process relates to a determination as to quality of the object (5) based on the image. The first inspection region includes a specific region not included in an inspection region other than the first inspection region of the plurality of inspection regions. The determining portion (22) is configured to execute a second process. The second process is a process of determining, based on a result of the first process executed on each of the plurality of inspection regions, the quality of the object (5).

This configuration enables the accuracy of a quality determination of the object (5) to be improved as compared with a case where the quality determination is made based on only the first inspection region or only the second inspection region of the object (5).

In an inspection device (1, 1A) of a second aspect referring to the first aspect, the determining portion (22) is configured to determine quality of each of the plurality of inspection regions in the first process. The determining portion (22) is configured to, when a determination result is bad for at least one of the plurality of inspection regions in the first process, determine in the second process that the object (5) is bad.

This configuration reduces the possibility that when some inspection regions of the plurality of inspection regions include abnormal features which are bad, the determining portion (22) overlooks the badness.

In an inspection device (1, 1A) of a third aspect referring to the second aspect, the determining portion (22) is configured to, when determining in the first process that the object (5) has an abnormal feature which is bad in a predetermined inspection region of the plurality of inspection regions, define a result of the first process executed on the predetermined inspection region as being bad, and the determining portion (22) is configured to, when determining in the first process that the object (5) has an abnormal feature which is not bad and the object (5) has no abnormal feature which is bad in the predetermined inspection region, define the result of the first process executed on the predetermined inspection region as being good.

This configuration reduces the possibility that when the object (5) has an abnormal feature which is bad and an abnormal feature which is not bad, the determining portion (22) overlooks the badness.

In an inspection device (1, 1A) of a fourth aspect referring to the first aspect, the determining portion (22) is configured to calculate determination values each representing a level of quality of a corresponding one of the plurality of inspection regions of the object (5) in the first process. The determining portion (22) is configured to determine, based on a sum of the determination values calculated in the first process, the quality of the object (5) in the second process.

This configuration reduces the possibility that when some inspection regions of the plurality of inspection regions include abnormal features which are bad, the determining portion (22) overlooks the badness.

An inspection device (1, 1A) of a fifth aspect referring to any one of the first to fourth aspects further includes a setting portion (24). The setting portion (24) is configured to set at least one inspection region of the plurality of inspection regions.

This configuration enables the inspection region to be set.

In an inspection device (1, 1A) of a sixth aspect referring to the fifth aspect, the setting portion (24) includes a user setting portion (241). The user setting portion (241) is configured to set the at least one inspection region of the plurality of inspection regions in accordance with an input given by a user.

This configuration enables the inspection region to be set in accordance with user's wishes.

In an inspection device (1, 1A) of a seventh aspect referring to the fifth or sixth aspect, the setting portion (24) includes a region deriving portion (242). The region deriving portion (242) is configured to set the at least one inspection region of the plurality of inspection regions in accordance with a predetermined rule.

This configuration enables the inspection region to be automatically set.

In an inspection device (1, 1A) of an eighth aspect referring to the seventh aspect, the region deriving portion (242) is configured to define an entirety of an inspection target region of the object (5) as the first inspection region.

This configuration enables the first inspection region to be automatically set.

In an inspection device (1, 1A) according to a ninth aspect referring to a seventh or eighth aspect, the region deriving portion (242) is configured to define a predetermined region in a region in which a predetermined abnormal feature which is bad is capable of occurring in the object (5) as the second inspection region.

This configuration enables the second inspection region to be automatically set.

In an inspection device (1, 1A) of a tenth aspect referring to the ninth aspect, the region deriving portion (242) is configured to define, as the second inspection region, the region, in which the predetermined abnormal feature which is bad is capable of occurring in the object (5), and whose area ratio to an entirety of an inspection target region of the object (5) is less than or equal to a predetermined value.

This configuration reduces the possibility that the determining portion (22) overlooks the badness in the second inspection region.

In an inspection device (1, 1A) according to an eleventh aspect referring to any one of the fifth to tenth aspects, the setting portion (24) is configured to set the second inspection region for each of features which the object (5) is capable of having.

This configuration enables the determining portion (22) to easily find the presence or absence of the plurality of features which the object (5) may have.

An inspection device (1, 1A) of a twelfth aspect referring to any one of the first to eleventh aspects further includes a learning portion (23). The learning portion (23) is configured to generate, based on a training data set, a determination model to be used by the determining portion (22) in the first process.

This configuration enables the determining portion (22) to execute the first process by using the determination model.

In an inspection device (1, 1A) of a thirteenth aspect referring to the twelfth aspect, the training data set includes a first training data set relating to the first inspection region and a second training data set relating to the second inspection region. The learning portion (23) is configured to generate, based on the first training data set, a first determination model corresponding to the first inspection region. The learning portion (23) is configured to generate, based on the second training data set, a second determination model corresponding to the second inspection region.

This configuration enables the accuracy of the determination to be increased as compared with a case where a determination model common to the first inspection region and the second inspection region is used.

In an inspection device (1, 1A) of a fourteenth aspect referring to the twelfth or thirteenth aspect, the training data set defines the object (5) having an abnormal feature which is bad as being bad and defines the object (5) having an abnormal feature which is not bad and having no abnormal feature which is bad as being good.

This configuration enables the content of the inspection of the object (5) to be concentrated on finding the abnormal feature which is bad.

An inspection device (1A) of a fifteenth aspect referring to any one of the twelfth to fourteenth aspects further includes an unknown image judging portion (25). The unknown image judging portion (25) is configured to judge whether or not the image input to the input portion (21) is an unknown image to which no image in the training data set corresponds. The determining portion (22) is configured to determine, further based on a judgement result by the unknown image judging portion (25), the quality of the object (5).

This configuration enables the quality of the object (5) to be determined based on whether or not the image input to the input portion (21) is an unknown image.

In an inspection device (IA) of sixteenth aspect referring to the fifteenth aspect, the unknown image judging portion (25) is configured to extract an input feature amount. The input feature amount is a feature amount of the image input to the input portion (21). The unknown image judging portion (25) is configured to judge the image input to the input portion (21) to be the unknown image when a distance between the input feature amount and a feature amount which is included in feature amounts of a plurality of images included in the training data set and which is closest to the input feature amount is greater than or equal to a threshold in a feature amount space.

This configuration enables the unknown image judging portion (25) to judge whether or not the image input to the input portion (21) is the unknown image.

In an inspection device (1A) of a seventeenth aspect referring to the fifteenth or sixteenth aspect, the determining portion (22) is configured to, when the unknown image judging portion (25) judges the image input to the input portion (21) to be the unknown image, determine that the object (5) is bad.

When the image is the unknown image, both a case where the object (5) is good and a case where the object (5) is bad are possible, but this configuration reduces the possibility that the object (5) which is bad is erroneously determined to be good. Thus, for example, the possibility that finished products of the object (5) include a defective product is reduced.

An inspection device (1, 1A) according to an eighteenth aspect referring to any one of the first to seventeenth aspects further includes a display portion (33). The display portion (33) is configured to display a determination result by the determining portion (22).

This configuration enables the determination result to be checked by a user.

Configurations other than the first aspect are not configurations essential for the inspection device (1, 1A) and may thus accordingly be omitted.

An inspection method of a nineteenth aspect includes: executing an input process of receiving an input of an image taken of an object (5): executing a first process relating to a determination as to quality of the object (5) based on the image on each of a plurality of inspection regions set on the object (5) in the image and including a first inspection region and a second inspection region, the plurality of inspection regions: and executing a second process of determining, based on a result of the first process executed on each of the plurality of inspection regions, the quality of the object (5). The first inspection region includes a specific region not included in an inspection region other than the first inspection region of the plurality of inspection regions.

This configuration enables the accuracy of a quality determination of the object (5) to be improved as compared with a case where the quality determination is made based on only the first inspection region or only the second inspection region of the object (5).

A program of a twentieth aspect is a program configured to cause one or more processors of a computer system to execute the inspection method of the nineteenth aspect.

This configuration enables the accuracy of a quality determination of the object (5) to be improved as compared with a case where the quality determination is made based on only the first inspection region or only the second inspection region of the object (5).

The above aspects should not be construed as limiting, and various configurations (including variations) of the inspection device (1, 1A) of the embodiment are implemented by an inspection method, a (computer) program, or a program stored in a non-transitory recording medium.

### REFERENCE SIGNS LIST

1, 1A Inspection Device
5 Object
21 Input Portion
22 Determining Portion
23 Learning Portion
24 Setting Portion
25 Unknown Image Judging Portion
33 Display Portion
241 User Setting Portion
242 Region Deriving Portion

1. An inspection device comprising:
an input portion configured to receive an input of an image taken of an object; and
a determining portion configured to execute a first process on each of a plurality of inspection regions including a first inspection region and a second inspection region, the plurality of inspection regions being set on the object in the image, the first process relating to a determination of as to quality of the object based on the image,
the first inspection region including a specific region not included in an inspection region other than the first inspection region of the plurality of inspection regions,
the determining portion being configured to execute a second process of determining, based on a result of the first process executed on each of the plurality of inspection regions, the quality of the object.

2. The inspection device of claim 1, wherein
the determining portion is configured to determine quality of each of the plurality of inspection regions in the first process, and
the determining portion is configured to, when a determination result is bad for at least one of the plurality of inspection regions in the first process, determine in the second process that the object is bad.

3. The inspection device of claim 2, wherein
the determining portion is configured to, when determining in the first process that the object has an abnormal feature which is bad in a predetermined inspection region of the plurality of inspection regions, define a result of the first process executed on the predetermined inspection region as being bad, and
the determining portion is configured to, when determining in the first process that the object has an abnormal feature which is not bad and the object has no abnormal feature which is bad in the predetermined inspection region, define the result of the first process executed on the predetermined inspection region as being good.

4. The inspection device of claim 1, wherein
the determining portion is configured to calculate determination values each representing a level of quality of a corresponding one of the plurality of inspection regions of the object in the first process, and
the determining portion is configured to determine, based on a sum of the determination values calculated in the first process, the quality of the object in the second process.

5. The inspection device of claim 1, further comprising a setting portion configured to set at least one inspection region of the plurality of inspection regions.

6. The inspection device of claim 5, wherein
the setting portion includes a user setting portion configured to set the at least one inspection region of the plurality of inspection regions in accordance with an input given by a user.

7. The inspection device of claim 5, wherein
the setting portion includes a region deriving portion configured to the set at least one inspection region of the plurality of inspection regions in accordance with a predetermined rule.

8. The inspection device of claim 7, wherein
the region deriving portion is configured to define an entirety of an inspection target region of the object as the first inspection region.

9. The inspection device of claim 7, wherein
the region deriving portion is configured to define a predetermined region in a region in which a predetermined abnormal feature which is bad is capable of occurring in the object as the second inspection region.

10. The inspection device of claim 9, wherein
the region deriving portion is configured to define, as the second inspection region, the region, in which the predetermined abnormal feature which is bad is capable of occurring in the object, and whose area ratio to an entirety of an inspection target region of the object is less than or equal to a predetermined value.

11. The inspection device of claim 5, wherein
the setting portion is configured to set the second inspection region for each of features which the object is capable of having.

12. The inspection device of claim 1, further comprising a learning portion configured to generate, based on a training data set, a determination model to be used by the determining portion in the first process.

13. The inspection device of claim 12, wherein
the training data set includes
a first training data set relating to the first inspection region and
a second training data set relating to the second inspection region, and
the learning portion is configured to
generate, based on the first training data set, a first determination model corresponding to the first inspection region and
generate, based on the second training data set, a second determination model corresponding to the second inspection region.

14. The inspection device of claim 12, wherein
the training data set
defines the object having an abnormal feature which is bad as being bad and
defines the object having an abnormal feature which is not bad and having no abnormal feature which is bad as being good.

15. The inspection device of claim 12, further comprising an unknown image judging portion configured to judge whether or not the image input to the input portion is an unknown image to which no image in the training data set corresponds, wherein
the determining portion is configured to determine, further based on a judgement result by the unknown image judging portion, the quality of the object.

16. The inspection device of claim 15, wherein
the unknown image judging portion is configured to
extract an input feature amount which is a feature amount of the image input to the input portion and
judge the image input to the input portion to be the unknown image when a distance between the input feature amount and a feature amount which is included in feature amounts of a plurality of images included in the training data set and which is closest to the input feature amount is greater than or equal to a threshold in a feature amount space.

17. The inspection device of claim 15, wherein
the determining portion is configured to, when the unknown image judging portion judges the image input to the input portion to be the unknown image, determine that the object is bad.

18. The inspection device of claim 1, further comprising a display portion configured to display a determination result by the determining portion.

19. An inspection method comprising:
executing an input process of receiving an input of an image taken of an object;
executing a first process relating to a determination as to quality of the object based on the image on each of the plurality of inspection regions set on the object in the image and including a first inspection region and a second inspection region; and
executing a second process,
the first inspection region including a specific region not included in an inspection region other than the first inspection region of the plurality of inspection regions,
the second process being a process of determining, based on a result of the first process executed on each of the plurality of inspection regions, the quality of the object.

20. A non-transitory computer-readable storage medium storing a computer program configured to cause one or more processor in a computer system to execute the inspection method of claim 19.
